(19) United States
(12) Patent Application Publication
(10) Pub. No.: US 2025/0346694 A1
(43) Pub. Date: Nov. 13, 2025

(54) PROCESS FOR CONTINUOUSLY POLYMERIZING CATIONICALLY POLYMERIZABLE MONOMERS IN INTENSIFIED REACTORS

(71) Applicant: Braskem S.A., Camaçari (BR)

(72) Inventors: Maurício Silveira Cadore, São Paulo City (BR); João Capistrano Nobre De Abreu, São Paulo City (BR); Márcio Henrique dos Santos Andrade, São Paulo City (BR); Maria Giuliana Torraga Uchiyama, São Paulo City (BR); Thiago Faheina Chaves, São Paulo City (BR); Danniel Panza, São Paulo City (BR); Desiree Meneghin De Souza, São Paulo City (BR); Roberta Lopes Do Rosário, São Paulo City (BR)

(73) Assignee: Braskem S.A., Camaçari (BR)

(21) Appl. No.: 19/175,803

(22) Filed: Apr. 10, 2025

Related U.S. Application Data
(60) Provisional application No. 63/645,406, filed on May 10, 2024.

(51) Int. Cl. C08F 110/10; B01J 19/00; B01J 19/06

(52) U.S. Cl. CPC C08F 110/10; B01J 19/006; B01J 19/0093; B01J 19/06; B01J 2219/00855; B01J 2219/00889

(57) ABSTRACT

A process of continuously producing polyisobutylene may include continuously feeding isobutylene, a catalyst, a co-catalyst and optionally a solvent into a milli-channel reactor; and continuously polymerizing at least a portion of the isobutylene to produce a polyisobutylene within a reaction mixture. A light-polyisobutylene produced by continuously feeding isobutylene, a catalyst, and optionally a solvent and a co-catalyst into a milli-channel reactor and continuously polymerizing at least a portion of the isobutylene to produce a polyisobutylene in a reaction mixture.

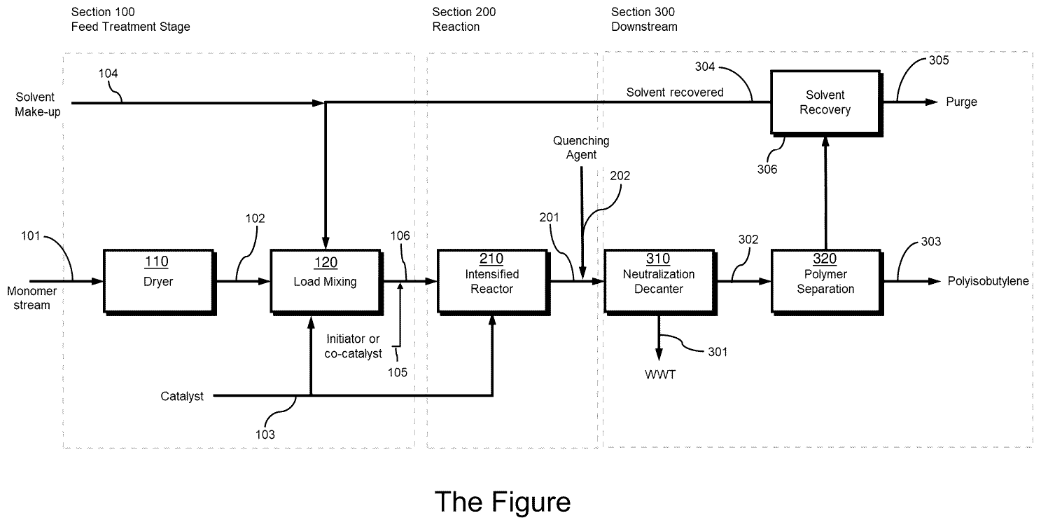

### CROSS REFERENCE TO RELATED APPLICATIONS

This application claims priority to U.S. Provisional Application Ser. No. 63/645,406, filed on May 10, 2024, hereby incorporated herein by reference.

### BACKGROUND

Polyisobutylene (PIB) are generally produced by cationic polymerization processes. Specifically, cationic polymerization is initiated by a proton donor species, by introducing a protonic acid (Bronsted acid) or an aprotic acid (Lewis acid) with a proton donor. Protonic acids are species capable of donating protons, such as H+ ions, capable of interacting with the double bond present in the monomer and promoting the initiation of polymerization through the formation of the living polymeric chain. Cationic polymerization initiated through the use of a Lewis acid occurs in the presence of a proton donor, also known as an initiator or co-catalyst, such as: water, alcohol, organic acids or t-butyl chloride. The catalyst generates charged species from the co-catalyst to form the catalytic complex capable of initiating the polymerization of isobutylene with a proton-counterion pair.

Product grade PIB is primarily defined by its viscosity and average number molecular weight (Mn). Commercially available PIBs are classified into three main categories: (i) high molecular weight PIBs (HPIB, Mₙ>100,000 gmol⁻¹); (ii) medium or intermediate molecular weight PIBs (MPIB, 10,000<Mₙ<100,000 gmol⁻¹) and (iii) low molecular weight PIBs (LPIB, Mₙ<10,000 gmol⁻¹). PIB's molecular weight can be changed by manipulation of process parameters such as solvent, catalyst type, co-catalyst type, reaction time, temperature of operation and so on.

In conventional PIB commercial process plants, the main processing sections are (i) butane feed preparation and drying for catalyst preparation, (ii) feed drying, (iii) reaction and (iv) treating and product recovery. Conventional PIB processes use multiple reactor types as reaction mediums, such as continuous stirred tank reactors (CSTR), loop reactors, shell-and-tube exchange reactors, recycle loop reactors and so forth. However, the continuous production of polyisobutylene using conventional reactors such as CSTRs or loop reactors do not have sufficient heat transfer capacity to effectively control the temperature for the polymerization of light molecular weight PIB. In traditional processes, due to limitations in heat transfer and mixing, monomer-to-polymer conversions are in the range of 40 to 60% on the first pass. Typically, the products require successive stages of separation and mixing to meet the final desired specifications.

In conventional polyisobutylene (PIB) commercial production facilities, the limited heat transfer capabilities, and imprecise control of critical process parameters, such as temperature and residence time, result in low molecular weight PIB constituting only a minor fraction of the overall production. Often, it is merely a by-product of the production of high or intermediate molecular weight PIBs. This limitation restricts the volume of low molecular weight PIB available for commercial sale and necessitates a series of separation steps to fractionate products of varying molecular weights.

### SUMMARY

It is an objective of the present disclosure to provide a process for continuously producing low and intermediate molecular weights polyisobutylene, comprising: continuously introducing cationically polymerizable monomers, a catalyst, a co-catalyst, and optionally a solvent into a milli-channel reactor; and continuously polymerizing at least a portion of the polymerizable monomers to form polyisobutylene within a reaction mixture.

Other aspects and advantages of the claimed subject matter will be apparent from the following description and the appended claims.

### BRIEF DESCRIPTION OF DRAWINGS

The embodiments are described in connection with the attached FIGURE.

The FIGURE is a process flow diagram according to one or more embodiments.

### DETAILED DESCRIPTION

Embodiments disclosed herein pertain to the utilization of a milli-channel reactor for the synthesis of polyisobutylene. Polyisobutylene polymerization is among the most rapid reactions in organic chemistry; even at exceptionally low temperatures, the reaction proceeds violently, generating a substantial heat flux due to its enthalpy of reaction. Given the highly exothermic nature of the reaction, temperature control in conventional reactors is imprecise due to heat transfer limitations. Precise control of the reaction temperature is crucial for ensuring product quality, catalyst longevity, degree of polymerization, and achieving the desired properties of the final product, such as molecular weight and polydispersity. To achieve the desired molecular weight in polyisobutylene (PIB) polymerization, the reaction components must be intimately intermixed, and the reaction time must be tightly controlled. The reactor design, mixing effects, flow dynamics within the reactor zone, and process conditions are critical factors contributing to the efficacy of the method. To address the technical challenges associated with polyisobutylene polymerization, the present disclosure provides a process that enhances control over reaction parameters through the use of intensified milli-channel microreactors. Specifically, employing a milli-channel reactor with superior mass and energy transfer coefficients and enhanced mixing, in conjunction with specific process conditions, can facilitate the efficient production of very-low, low, and intermediate molecular weight polyisobutylene.

The utilization of one or more milli-channel reactors for the synthesis of polyisobutylene may establish new standards in flow patterns and enhanced control of process parameters (e.g., temperature, residence time), thereby enabling increased selectivity and yields for the highly exothermic cationic polymerization of PIB. Additionally, the significantly higher surface-to-volume ratio of the milli-channel reactor, compared to conventional reactors, results in markedly improved heat transfer between the process and service medium, as well as intimate intermixing of reaction components within the reaction zone. Consequently, the use of milli-channel reactors facilitates superior heat transfer and/or dissipation, allowing even highly exothermic reactions to be conducted virtually isothermally. This characteristic may favor cationic polymerization and enable better control over tailoring the required product specifications. Thus, the embodiments disclosed herein offer alternatives for increasing yields in PIB process units by promoting improved process conditions and intimate molecular interaction within the reaction mixture during the cationic polymerization of isobutylene.

The production process described herein can achieve monomer conversion rates significantly higher than those of incumbent conventional processes, exceeding 80 wt. % and, under specific conditions, surpassing 90 wt. %. This is accomplished with residence times that are 20 to 40 times shorter than those of conventional processes. Reduced residence times result in smaller equipment requirements and lower capital expenditures.

Embodiments disclosed herein pertain to a method for the continuous production of polyisobutylene, utilizing the cationic polymerization process described above. In this method, isobutylene, maintained under pressure in the liquid phase, is contacted with a catalyst, and optionally a solvent and/or a co-catalyst, to initiate polymerization. The polymerization occurs within a milli-channel reactor, which may be baffled or unbaffled and may contain static mixers. This configuration ensures intimate mixing of the reaction mixture even at low volumetric flow rates.

The isobutylene monomer is polymerized using organic carbocation intermediates. The continuous polymerization occurs within a milli-channel reactor, which facilitates precise control over process parameters, including residence time, reaction mixture composition, heat transfer, temperature, pressure, and catalyst/co-catalyst ratio, among others.

In one or more embodiments, prior to polymerization, there may be an optional premixing zone, vessel, or step where isobutylene is contacted with a catalyst, and optionally with a co-catalyst and/or a solvent, to form a premixture. This premixture can be continuously fed into one or more milli-channel reactors or milli-channel reactor zones. Additionally, isobutylene and/or catalyst can be introduced at various points within the milli-channel reactor. The polymerizable monomer stream can be mixed immediately upstream of the reactor, at the entrance of the first reactor zone, or at different points along the length of the reactor. The milli-channel reactor, whether baffled or unbaffled and with or without static mixers, ensures adequate intermixing of the components. In other embodiments, there may be no premixing zone, vessel, or step, and intimate mixing occurs within the reactor itself. Optionally, prior to polymerization, a feedstock pre-treatment section may be employed to remove impurities and reaction poisons, such as water, alcohols, and nitrogenated compounds.

In the disclosed embodiments, the polymerization occurs within one or more milli-channel reactors. Additionally, a post-polymerization stage may be included, featuring a vessel at the reactor outlet for the collection and accumulation of the reaction mixture. This vessel can discharge the mixture to subsequent process stages, such as the separation of the polyisobutylene product from unreacted hydrocarbons, catalyst abatement, monomer recovery, solvent recovery, co-catalyst, and oligomer separation. In one or more embodiments, the recovered monomer, unreacted hydrocarbons, and solvent can be recycled back into the process. This separation is preferably conducted in a sequence of distillation columns for monomer and solvent recovery, followed by water removal steps.

Referring to The FIGURE, a generalized process flow diagram for polyisobutylene production according to one or more embodiments is shown. The process is divided in three process sections called Section 100 or Feed Treatment Stage, Section 200 or Reaction and, Section 300 or Downstream. First, in a feed treatment stage 100, a monomer or monomer containing feed stream 101 is charged into a Dryer or Drying vessel 110 such as a fixed bed dryer, to remove water prior to continuously feeding stream 102 to the load mixing vessel 120. The catalyst and/or catalyst solution or suspension is added into the mixer 120 from stream 103 and the optional solvent 104 or optional recovered solvent 304 is charged to mixing vessel or mixer device 120 to form a feed mixture 106. The treated feed mixture 106 is continuously fed to the intensified reactor 210 for polymerization where at least a portion of the isobutylene is polymerized to produce polyisobutylene in a reaction mixture. An initiator or co-catalyst stream 105 is optionally fed to intensified reactor 210. As described herein, the reactor 210 is a milli-channel reactor. The reaction output 201 is neutralized using a quenching agent 202 that neutralizes the catalyst and stops the polymerization reaction. Lastly, after the polyisobutylene forms, it is discharged to a downstream stage 300. The downstream stage 300 may include, for example, catalyst neutralization in neutralization decanter 310, treating the reaction mixture after neutralization in stream 302, and one or more separations at separator 320 to recover at least one monomer, unreacted hydrocarbons, solvent 304 from solvent recovery unit 306, co-catalyst and aqueous solution 301, and oligomers 305 and a final product polyisobutylene (PIB) stream 303. The downstream stage may also optionally include recycling recovered components to the reactor 210.

In one or more embodiments, the at least one catalyst may be introduced into the reactor in the form of a solution or suspension in organic media. The solution may include a dilution of the catalyst in one or more organic solvents in a proportion of 5 to 20 wt. % catalyst, the organic solvents being selected from a group consisting of n-hexane, isopentane, n-heptane, iso-octane, n-octane, n-butane, isobutane a C4 cut, and mixtures thereof. The suspension may include a mixture of the catalyst with polyisobutylene, mineral oil, grease, or mixture thereof, said mixtures containing 2 to 30 wt. % catalyst. The catalyst solution or catalyst suspension may then be transferred to the reactor through pumping, or by any other suitable pressure differential means.

In one or more embodiments, the monomer feed 102 introduced into vessel 120 comprises isobutylene at a concentration ranging from 5 to 80% by weight, such as from 10% to 60%, and preferably from 20% to 45% by weight. The monomer feed, in accordance with one or more embodiments of the present disclosure, may be selected from Raffinate 1, or a mixture of Raffinate 1 and Raffinate 2, or isobutylene in a hydrocarbon feed mixture. For example, in one or more embodiments, isobutylene may be sourced from C4 and C5 cuts obtained by the catalytic dehydrogenation of isobutane from naphtha steam crackers and fluid catalytic systems, and thus may contain other C4 and C5 species along with the isobutylene.

As mentioned above, the monomer feed may optionally be combined with a solvent 104 in the vessel load mixer 120. In one or more embodiments, the solvent may be an organic solvent or the unreacted fraction from the polymerization reactor 210. For example, in one or more embodiments, the solvent may be selected from the group consisting of toluene, hexane, isopentane, heptane, iso-octane, n-butane, isobutane, methylcyclohexane, alkanes, a C4 mixture, a C4 and C5 mixture, or other mixtures thereof.

The monomer feed and optional solvent may be dried to remove water (as water acts as a reaction poison when present in stoichiometric excess relative to the catalyst) before being continuously fed into the reactor. The drying stage is particularly crucial for the use of milli-channel reactors due to the intimate contact between the catalyst, co-catalyst, and monomer in this specific reactor, where the impact of trace amounts of any chemical component is amplified.

In addition to the monomer feed and optional solvent, a catalyst 103 and optional co-catalyst 105 may be introduced into the intensified reactor 210, the mixing vessel 120, or even the feed mixture 106. In one or more embodiments, the catalyst 103 and optional co-catalyst 105 are mixed with the monomer feed prior to introduction into the reactor 210, such that the monomer feed acts as a catalyst carrier, and the premixture of monomer and catalyst is continuously fed into the reactor 210. However, in other embodiments, the catalyst and optional co-catalyst are fed into the reactor 210 separately from the monomer feed and optional solvent. When introduced separately, the catalyst can be used to fine-tune and achieve specific product properties, particularly polydispersity.

According to one or more embodiments, the reaction mechanism may involve cationic polymerization with a single initiation step. In the cationic polymerization process disclosed herein, the initiation step involves the catalyst and co-catalyst reacting to form an acid complex that functions as a proton donor. Surprisingly, it was observed that the addition of a co-catalyst was not required to activate the catalytic complex in the milli-channel reactor. The minimal amount of water present in the monomer stream, ranging from 2 to 10 ppm, was sufficient to form the acidic complexes and achieve adequate reaction levels, thereby eliminating the need for an additional co-catalyst stream.

According to one or more embodiments, the catalyst may be selected from the group consisting of titanium tetrachloride (TiCl₄), aluminum trichloride (AlCl₃), ethyl aluminum dichloride (EtAlCl₂), 1-ethyl-3-methylimidazolium tetra chloroaluminate (Emim [AlCl₄]) and 1-ethyl-3-methylimidazolium tetrachloroferrate (Emim [FeCl₄]).

According to one or more embodiments, the optional co-catalyst may be selected from the group consisting of water, dibutyl ether (C₈H₁₈O), Di isopropyl ether (iPr₂O) and diethyl ether (Et₂O). Additionally, the catalyst to co-catalyst mass ratio may have a range of 10 to 2,800 or 3000, preferably a range of 30 to 1500, more preferably a range of 300 to 1500 wt./wt.

According to anyone of the embodiments, the mass ratio of the catalyst relative to isobutylene is in the range of 5000 to 60,000 ppm weight, preferably in a range of 10,000 to 50,000 and, more preferably in a range of 20,000 to 40,000 ppm weight. For instance, the mass concentration of catalyst relative to the isobutylene present in the polymerizable stream may be in the range of 1,600 to 40,000 ppm.

Referring again to The FIGURE, the reactor 210 is an intensified milli-channel system, optionally containing micro-structured static mixer inserts partially filling the reactor tubes. As used herein, a milli-channel reactor has channel sizes in the millimeter or sub-millimeter range. When the channel size is in the sub-millimeter range, the milli-channel reactor may also be referred to as a microreactor, comprising one or more monomer inlets, one or more catalyst inlets, and one or more product outlets. The a microreactor may include a shell-and-tube configuration that includes tubes and a reactor shell, wherein the tubes are also referred to as channels and where the milli-channel reactor has a surface-to-volume ratio of at least 500 m²/m³. Further, each of the channels of the said milli-channel reactor may be identical to the other and each of the channels can optionally be filled with micro structured static mixers, a block of micro structured static mixers, or baffles. Additionally, the reactor temperature may be controlled using an external refrigeration fluid system, wherein the fluid system is pumped through the reactor shell.

It is also envisioned that the microreactor may include measurement and/or control instruments, probes, or sensors, enabling online or continuous measurement of parameters such as temperature, pressure, flow rates, conversion rates, and viscosity. While The FIGURE depicts a single milli-channel reactor with multiple identical zones operating in parallel, for scaling up, it is envisioned that additional reactor zones may be added in parallel to increase the production rate.

In more than one embodiment, the one or more milli-channel reactors or microreactors or reaction zones of the reaction section has a surface-to-volume ratio in the range of 500 to 3000 m²/m³, such as from a lower limit of any of 500, 700 or 1000 m²/m³, to an upper limit of any of 2000, 2500 or 3,000 m²/m³, where any lower limit can be used in combination with any upper limit.

In one or more embodiments, the polymerization temperature may be controlled using an external refrigeration fluid. The refrigeration system comprises at least one device capable of providing or discharging heat, such as jacket sections, allowing for temperature control that may vary between different areas. As needed, the utility can reheat or cool the milli-channel reactor. It is envisioned that a jacket, or jacket segments, would enable the control and maintenance of a constant temperature or a uniform temperature profile gradient in the milli-channel reactor by means of a heat source (such as steam or circulating hot fluid) or a circulating coolant (such as cooling or chilled fluid). A fluid inlet and outlet can be specific to one jacket section or multiple jacket sections. Although not illustrated, fluid circulation in the jacket should be provided by a pump. For example, the jacket may be used to maintain the reaction temperature at 40° C. with a variability of+1° C. Since polyisobutylene polymerization is an exothermic reaction, a cooling fluid will be circulated to maintain the reaction temperature.

In one or more embodiments, the polymerization occurs under a pressure range of 5 to 100 kgf/cm², preferably between 10 and 50 kgf/cm², and more preferably between 15 and 20kgf/cm². The inventors observed that pressure does not impact the polymerization rate. The pressure should be defined to maintain the species in the liquid phase at the reaction temperature and composition at the reactor inlet.

In one or more embodiments, the polymerization occurs at any temperature within the range of 20° C. to 100° C., but preferably within the range of 30° C. to 60° C. To achieve effective mixing, one or more milli-channel reactors or microreactors may employ round or rectangular tubes with internal static mixers that divert the flow of the reaction mixture and promote intimate contact between reactants. These mixers can be designed as, but are not limited to, baffles, twisted tubes, corrugated tubes, and rectangular section static mixing elements.

For example, the baffles can be in the form of square-edged, rectangular, sharp, or smooth baffles or static mixers. In relation to the reactor wall, they can be positioned at right or acute angles, and can take the form of rings, wires, or washers. Distinct types of static mixers include central axial baffles, round-edged helical baffles, wire wool baffles, single-orifice baffles, comb-shaped inserts, and disc and doughnut baffles.

Alternative to baffles, in one or more embodiments, the reactor wall itself can be shaped to create obstacles and enhance mixing and heat transfer, as is the case with twisted (with different profiles such as flat oval, oval, among others) or corrugated tubes, or other wall shape configurations.

The configuration and spacing of the inserts or baffles may be modified in accordance with the progression of the polymerization reaction. Consequently, these parameters can vary in the regions where polymerization initiates, in the regions where polymerization is actively occurring, and in the regions where polymerization concludes.

Instead of baffles, in more than one embodiment, the one or more milli-channel reactors or microreactors may comprise comb-like mixing elements and/or static mixers.

As mentioned above, the presence of baffles, internal obstacles or mixing elements may be used during the polymerization method to enhance mixing, heat transfer effects and residence time distribution.

According to any of the embodiments wherein the polymerization process involves multiple milli-channel reactors, it is contemplated that the plurality of reactors may be configured either in parallel or in series. When arranged in series, each inlet of one or more reactors is connected to the outlet of the preceding reactor within the series.

The outlet of the reactor, or the outlet of the most downstream reactor in certain embodiments, may be equipped with an outlet valve to regulate the quantity of polyisobutylene exiting the vessel. This configuration ensures a polymerization residence time ranging from at least 10 seconds or 1 minute to up to 7 minutes, measured from the injection of the isobutylene monomer into the reactor to the exit of the polyisobutylene polymer. Additionally, the outlet of the reactor, or the most downstream reactor, is equipped with a back pressure regulator valve to prevent the vaporization of liquefied gases within the reactor.

The polyisobutylene polymer and any other intended chemicals are discharged from the reaction section into a downstream process stage 300, as depicted in The FIGURE, where the following non-limiting processes occur: catalyst neutralization, co-catalyst separation, and chlorides removal in a neutralization decanter; polymer product separation and PIB isolation; solvent recovery; and oligomers separation. For instance, referring to THE FIGURE, the reactor output is combined with water and soda or water and ethanol in a neutralizer to neutralize the reaction product mixture, deactivate the catalyst, and remove water, soda, and aluminum salts. The neutralized reaction product mixture may optionally be fed to a treatment bed to remove chlorine before being sent to a series of separators, including: a first separator to remove unreacted monomer and light solvents; a second separator to remove solvent and impurities (with solvent recycled back to the feed treatment stage); and a third separator (such as a flash drum) to separate oligomers from the polyisobutylene product.

Due to the process requirements, the use of milli-channel reactors alongside adjustments on temperature, catalyst concentration and other process parameters are likely to benefit the initiation step of polyisobutylene's cationic polymerization, leading to a higher conversion of isobutylene into small polyisobutylene chains, which characterizes light PIB's molecular weight distribution. Thus, the method according to the present disclosure makes it possible to efficiently control the molecular weight of the polyisobutylene formed by manipulating one or more of the following process variables: residence time and catalyst concentration and temperature and cocatalyst concentration.

Thus, multiple embodiments are contemplated. For instance, the reaction may occur in one or more milli-channel reactors or microreactors. Furthermore, the reaction may proceed with or without comb-like mixing elements. Advantageously, the reaction is conducted with minimal co-catalyst concentration, with the requisite co-catalyst concentration being present in the monomer feed. In this embodiment, there is no need to introduce additional co-catalyst to form the catalytic complex.

According to any one of the embodiments, the polyisobutylene formed is a light-polyisobutylene or low-molecular weight polyisobutylene, comprising a number average molecular weight of 280 to 1500 g/mol, depending on the desired product specification, such as from a lower limit of any of 280, 400 or 500 g/mol to an upper limit of any of 900, 1050, 1200 or 1500 g/mol, where any lower limit can be used in combination with any upper limit. The light-polyisobutylene further comprises a polydispersity level lower than 3 and, preferably between 1 and 2.

According to anyone of the embodiments, the light-polyisobutylene comprises a viscosity ranging from 5 to 500 cSt at 37.8° C., according to the ASTM D-445 standard, such as from a lower limit of any of 5, 10 or 15 cSt to an upper limit of 50, 120, 150, or 600 cSt, where any lower limit may be paired with any upper limit.

### EXAMPLES

The one or more embodiments described above are illustrated by the examples which follow.

### Process Example 1

A liquid polymerizable hydrocarbon stream containing isobutylene and traces of water (composition according to Table 1) was mixed continuously with a catalyst solution containing Ethyl Aluminum Dichloride using a T mixer or pre-mixer device. Immediately after the mixer device the pre-mixed stream enter the reaction zone, comprising a series of milli-channels and micro structured static-mixers, where the polymerization occurs under specific process conditions. The reaction temperature is controlled by external cooling devices, pumping refrigerated water into the reactor shell. The reactor pressure is controlled by a back pressure regulator installed immediately downstream of the reactor. The reaction products are quenched using ethanol. Then the organic and inorganic phases are separated. Then the product Polyisobutylene is obtained from the organic phase by distillation. The experiments were conducted at different flow rates, catalyst rates, cocatalyst concentrations and residence times, as exposed in Table 2. The polyisobutylene obtained in the Process Example 1 the experiments EXP 1-01 to EXP 1-05 have the properties listed in Table 2.

The molecular weight (number average molecular weight, Mn) and molecular weight distribution (MWD) presented in all of the preceding process examples were obtained by gel permeation chromatography (GPC) method. Polydispersity Index (PDI) is the ratio of the weight average molecular weight (Mw) to the number average molecular weight (Mn)

$$PDI = \frac{{M}_{w}}{{M}_{n}} .$$

The results indicate that the molecular weight (Mn) and polydispersity index (PDI) of the polyisobutylene are significantly influenced by the Catalyst/Isobutene ratio and Catalyst/Co-catalyst ratio.

In Experiment EXP 1-01, conducted at a catalyst flow rate of 0.34 ml/min, the polyisobutylene exhibited an Mn of 319 g/mol and a PDI of 1.9. In Experiment EXP 1-02, maintaining the same catalyst flow rate but under different conditions, the Mn decreased to 294 g/mol and the PDI to 1.7, indicating a narrower molecular weight distribution. The reduction in the Mn value may be related to the increase in pressure in the reactor, ensuring that the raffinate is mostly in the liquid phase, promoting intimate mixing with the catalyst.

Reducing the Catalyst/Isobutene ratio to 15928 ppm wt. and the Catalyst/Co-catalyst ratio to 1385 wt./wt. in Experiments EXP 1-03 to EXP 1-05 led to higher Mn values (387 g/mol and 419 g/mol) and broader molecular weight distributions (PDI of 2.2). These experiments demonstrate that higher Catalyst/Isobutene ratios and Catalyst/Co-catalyst ratios favor the production of polyisobutylene with low molecular weights and narrow distributions.

The residence time was maintained at approximately 3.7 minutes across all experiments, allowing for a clear comparison of the effects of catalyst flow rate. The results suggest that optimizing these parameters can significantly enhance the properties of the resulting polyisobutylene.

### Process Example 2

Alternatively to Process Example 1, the said liquid polymerizable hydrocarbon stream containing isobutylene and traces of water (composition according to Table 1) was first mixed with an organic solvent and this mixture was then pumped and mixed continuously with a catalyst solution containing Ethyl Aluminum Dichloride using a T mixer or pre-mixer device. The experiments were conducted at different flow rates, catalyst rates, cocatalyst concentrations and residence times, as exposed in Table 1. The polyisobutylene obtained in the Process Example 2 the experiments EXP 2-01 to EXP 2-04 have the properties listed in Table 2.

In Experiments EXP 2-01 to EXP 2-03, conducted with a Catalyst/Isobutene ratio of 51154 ppm wt. and a Catalyst/Co-catalyst ratio of 466 wt./wt., the polyisobutylene exhibited Mn values ranging from 411 g/mol to 433 g/mol and PDI values of 2.3 and 1.8. Reducing the Catalyst/Isobutene ratio to 34046 ppm wt. and the Catalyst/Co-catalyst ratio to 324 wt./wt. in Experiment EXP 2-04 led to a decrease in Mn to 389 g/mol and a PDI of 1.8, indicating a narrower molecular weight distribution.

In Experiment EXP 2-04, the raffinate flow rate and solvent flow rate were increased to 6.19 ml/min and 5.83 ml/min, respectively, while maintaining the same catalyst flow rate. This change led to a decrease in Mn to 389 g/mol and a PDI of 1.8, indicating a narrower molecular weight distribution. The reduced residence time of 2.44 minutes in this experiment also contributed to the observed changes in molecular weight and distribution.

The results suggest that optimizing the flow rates and residence time can significantly enhance the properties of the resulting polyisobutylene. Higher catalyst flow rates and consistent raffinate and solvent flow rates favor the production of polyisobutylene with higher molecular weights and broader distributions. Conversely, increasing the raffinate and solvent flow rates while maintaining the same catalyst flow rate results in lower molecular weights and narrower distributions.

### Process Example 3

Alternatively to Process Example 1, the liquid polymerizable hydrocarbon stream containing isobutylene and water (composition according to Table 1) was mixed continuously with a catalyst suspension containing Aluminum Trichloride (AlCl3) using a T mixer or pre-mixer device. Preceding the pre-mixer device, the catalyst suspension is pumped using a high-pressure syringe pump. The experiments were conducted at different flow rates, catalyst rates, cocatalyst concentrations and residence times, as exposed in Table 2. The polyisobutylene obtained in the Process Example 3 the experiments EXP 3-01 to EXP 3-06 have the properties listed in Table 2.

In Experiment EXP 3-01, conducted with a Catalyst/Isobutene ratio of 42639 ppm wt. and a Catalyst/Co-catalyst ratio of 1262 wt./wt., the polyisobutylene exhibited an Mn of 570 g/mol and a PDI of 2.5. In Experiments EXP 3-02 and EXP 3-03, reducing the Catalyst/Isobutene ratio to 21513 ppm wt. and the Catalyst/Co-catalyst ratio to 1050 wt./wt. resulted in Mn values of 380 g/mol and 392 g/mol, respectively, with PDI values of 2.3 and 2.4.

Experiment EXP 3-04, further reducing the Catalyst/Isobutene ratio to 9999 ppm wt. and the Catalyst/Co-catalyst ratio to 313 wt./wt. resulted in an Mn of 498 g/mol and a PDI of 2.5. Experiment EXP 3-05, conducted under similar conditions, showed an increase in Mn to 617 g/mol and a decrease in PDI to 2.2, indicating a narrower molecular weight distribution.

In Experiment EXP 3-06, increasing the Catalyst/Isobutene ratio to 19998 ppm wt. and the Catalyst/Co-catalyst ratio to 1027 wt./wt. resulted in an Mn of 616 g/mol and a PDI of 2.4. These results demonstrate that lower Catalyst/Isobutene ratios and Catalyst/Co-catalyst ratios favor the production of polyisobutylene with higher molecular weights and broader distributions.

TABLE 1

| | | | | | | | | Catalyst/ | | |
|---|---|---|---|---|---|---|---|---|---|---|
| | | | Catalyst | Raffinate | Solvent | Isobutene | Catalyst/ | Co- | Residence | |
| Process | | | Flow | Flow | Flow | (% by | Isobutene | catalyst | time | Pressure |
| Ex. | Expt.# | Catalyst | (ml/min) | (ml/min) | (ml/min) | wt.) | (ppm wt.) | (wt./wt.) | (min) | (bar) |
| 1 | EXP | EADC | 0.34 | 7.94 | 0.00 | 43% | 18051 | 1491 | 3.68 | 10 |
| | 1-01 | | | | | | | | | |
| 1 | EXP | EADC | 0.34 | 7.94 | 0.00 | 43% | 18051 | 1491 | 3.68 | 15 |
| | 1-02 | | | | | | | | | |
| 1 | EXP | EADC | 0.3 | 7.94 | 0.00 | 43% | 15928 | 1385 | 3.70 | 15 |
| | 1-03 | | | | | | | | | |
| 1 | EXP | EADC | 0.3 | 7.94 | 0.00 | 43% | 15928 | 1385 | 3.70 | 15 |
| | 1-04 | | | | | | | | | |
| 1 | EXP | EADC | 0.3 | 7.94 | 0.00 | 43% | 15928 | 1385 | 3.70 | 15 |
| | 1-05 | | | | | | | | | |
| 2 | EXP | EADC | 0.50 | 4.12 | 3.88 | 43% | 51154 | 466 | 3.59 | 15 |
| | 2-01 | | | | | | | | | |
| 2 | EXP | EADC | 0.50 | 4.12 | 3.88 | 43% | 51154 | 466 | 3.59 | 15 |
| | 2-02 | | | | | | | | | |
| 2 | EXP | EADC | 0.50 | 4.12 | 3.88 | 43% | 51154 | 466 | 3.59 | 15 |
| | 2-03 | | | | | | | | | |
| 2 | EXP | EADC | 0.50 | 6.19 | 5.83 | 43% | 34046 | 324 | 2.44 | 15 |
| | 2-04 | | | | | | | | | |
| 3 | EXP | AlCl3 | 1.0 | 7.63 | 0.00 | 42% | 42639 | 1262 | 3.54 | 8.7 |
| | 3-01 | | | | | | | | | |
| 3 | EXP | AlCl3 | 0.5 | 7.45 | 0.00 | 43% | 21513 | 1050 | 3.84 | 10.5 |
| | 3-02 | | | | | | | | | |
| 3 | EXP | AlCl3 | 0.5 | 7.45 | 0.00 | 43% | 21513 | 1050 | 3.84 | 10.5 |
| | 3-03 | | | | | | | | | |
| 3 | EXP | AlCl3 | 1.0 | 7.94 | 0.00 | 43% | 9999 | 313 | 3.41 | 10.5 |
| | 3-04 | | | | | | | | | |
| 3 | EXP | AlCl3 | 1.0 | 7.94 | 0.00 | 43% | 9999 | 313 | 3.41 | 9 |
| | 3-05 | | | | | | | | | |
| 3 | EXP | AlCl3 | 0.50 | 7.94 | 0.00 | 43% | 19998 | 1027 | 3.61 | 9 |
| | 3-06 | | | | | | | | | |

TABLE 2

| | | Mn | |
|---|---|---|---|
| Process Example | Experiment | (g/mol) | Polydispersity |
| 1 | EXP 1-01 | 319 | 1.9 |
| 1 | EXP 1-02 | 294 | 1.7 |
| 1 | EXP 1-03 | 387 | 2.2 |
| 1 | EXP 1-04 | 286 | 1.7 |
| 1 | EXP 1-05 | 419 | 2.2 |
| 2 | EXP 2-01 | 411 | 2.3 |
| 2 | EXP 2-02 | 433 | 2.3 |
| 2 | EXP 2-03 | 415 | 1.8 |
| 2 | EXP 2-04 | 389 | 1.8 |
| 3 | EXP 3-01 | 570 | 2.5 |
| 3 | EXP 3-02 | 380 | 2.3 |
| 3 | EXP 3-03 | 392 | 2.4 |
| 3 | EXP 3-04 | 498 | 2.5 |
| 3 | EXP 3-05 | 617 | 2.2 |
| 3 | EXP 3-06 | 616 | 2.4 |

### Process Example 4

Alternatively to any of the preceding Process Examples, the pre-mixer device can be removed and the polymerizable hydrocarbon stream, as well as the catalyst stream, can be fed direct to reactor port. In this case, the first reactor zone or channel works as the pre-mixer, simultaneously with the ongoing reaction.

### Process Example 5

Alternatively to the use of external solvents to reduce isobutylene concentrations in the feeding stream, the unreacted fraction of the polymerizable hydrocarbon stream can be totally or partially recirculated from the reactor discharge to be mixed with the raw polymerizable hydrocarbon stream under mass flow ratio control.

### Process Example 6

Alternatively to Process Example 1, Using a feedstock having the monomer concentration as described in Table 1 and methylcyclohexane as solvent, a polyisobutylene product was obtained in accordance with the procedure of Process Example 2. The influence of the temperature on polyisobutylene properties was evaluated. The product was analyzed using GPC and the process conditions and results are presented in Table 3.

TABLE 3

| | | | | | | Cat/Co- | | | |
|---|---|---|---|---|---|---|---|---|---|
| | | | | | Residence | Cat | | | |
| | Temperature | | Co- | | Time | Ratio | Conversion | Mn | |
| Experiment | (° C.) | Catalyst | Catalyst | Solvent | (min) | wt./wt. | (%) | (g/mol) | PDI |
| EXP 6-01 | 22 | Ethyl | Water | Methylcyclohexane | 1 | 30 | 90.0 | 2926 | 1.98 |
| | | aluminum | | | | | | | |
| | | dichloride | | | | | | | |
| | | (EtAlCl₂) | | | | | | | |
| EXP 6-02 | 45 | Ethyl | Water | Methylcyclohexane | 1 | 30 | 82.5 | 2717 | 2.19 |
| | | aluminum | | | | | | | |
| | | dichloride | | | | | | | |
| | | (EtAlCl₂) | | | | | | | |
| EXP 6-03 | 55 | Ethyl | Water | Methylcyclohexane | 1 | 30 | 80.0 | 2011 | 1.0 |
| | | aluminum | | | | | | | |
| | | dichloride | | | | | | | |
| | | (EtAlCl₂) | | | | | | | |

As can be seen from Table 3, the polybutylenes prepared according to the Runs presented in Example 6 of the present disclosure have a molar mass distribution in accordance with the range corresponding to low PIB. The effect of temperature was evaluated and the results shown reduction of conversion with the temperature increase. The polymer samples analyzed exhibit a molecular weight distribution characterized by the weight average molecular weight (Mw) and the number average molecular weight (Mn). The calculated values of Mn and PDI for the samples are presented in Table 3. The effect of varying the synthesis conditions on Mn and PDI was evaluated, revealing that changes in reaction parameters significantly influence the molecular weight distribution. The results demonstrate that temperature has a significant impact on the polymerization process. As the temperature increases, the conversion rate decreases, and the molecular weight distribution changes. Lower temperatures favor higher conversion rates and higher molecular weights with a broader distribution, while higher temperatures result in lower molecular weights and a more uniform distribution.

### Process Example 7

Using a feedstock having the composition as described in Table 1, a polyisobutylene product was obtained in accordance with the procedure of Process Examples 2. The influence of the co-catalyst and residence time on polyisobutylene properties was evaluated. The product was analyzed by GPC and the process conditions are presented in Table 4.

TABLE 4

| | | | | | Residence | Cat/Co- | | | |
|---|---|---|---|---|---|---|---|---|---|
| | Temperature | | Co- | | Time | Cat Ratio | Conversion | Mn | |
| Experiment | (° C.) | Catalyst | Catalyst | Solvent | (min) | wt./wt. | (%) | (g/mol) | PDI |
| 1 | 20 | Ethyl | Isopropyl | Methylcyclohexane | 0.5 | 30 | 8.0 | 1999 | 2.98 |
| | | aluminum | ether (iPr₂O) | | | | | | |
| | | dichloride | | | | | | | |
| | | (EtAlCl₂) | | | | | | | |
| 2 | 20 | Ethyl | Isopropyl | Methylcyclohexane | 2.6 | 30 | 79.0 | 2717 | 2.10 |
| | | aluminum | ether (iPr₂O) | | | | | | |
| | | dichloride | | | | | | | |
| | | (EtAlCl₂) | | | | | | | |

As can be seen from Table 4, the polybutylenes prepared according to the Runs presented in Example 7 of the present disclosure have a molar mass distribution in accordance with the range corresponding to low PIB. The effect of temperature and residence time was evaluated, and the results show a significant variation in conversion and molecular weight distribution.

In Run 1, conducted at 20° C. with a residence time of 0.5 minutes, the conversion rate was observed to be 8.0%, indicating limited polymerization under these conditions. The average molecular weight (Mn) was determined to be 1999 g/mol, with a polydispersity index (PDI) of 2.98. This high PDI value suggests a broad molecular weight distribution, which is characteristic of a less controlled polymerization process. In contrast, Run 2, also conducted at 20° C. but with an increased residence time of 2.6 minutes, demonstrated a significantly higher conversion rate of 79.0%. The Mn for this run was 2717 g/mol, and the PDI was 2.10. The lower PDI value compared to Run 1 indicates a narrower molecular weight distribution, suggesting improved control over the polymerization process with the extended residence time. The use of isopropyl ether (iPr₂O) as a co-catalyst at 20° C. with varying residence times resulted in lower conversion rates and broader molecular weight distributions compared to the use of water as a co-catalyst at higher temperatures.

While the scope of the composition and method will be described with several embodiments, it is understood that one of ordinary skill in the relevant art will appreciate that numerous examples, variations, and alterations to the compositions and methods described herein are within the scope and spirit of the disclosure. Accordingly, the embodiments described are presented without any loss of generality and without imposing limitations on the disclosure. Those skilled in the art will understand that the scope includes all possible combinations and uses of the particular features described in the specifications. Although only a few example embodiments have been described in detail above, those skilled in the art will readily appreciate that numerous modifications can be made to the example embodiments without materially departing from the invention. Accordingly, all such modifications are intended to be included within the scope of this disclosure as defined in the following claims. In the claims, means-plus-function clauses are intended to cover the structures described herein as performing the recited function, and not only structural equivalents but also equivalent structures. It is the express intention of the applicant not to invoke 35 U.S.C. § 112 (f) for any limitations of any of the claims herein, except for those in which the claim expressly uses the words ‘means for’ together with an associated function.

What is claimed is:

1. A process for continuously producing low and intermediate molecular weights polyisobutylene, comprising:
(a) continuously introducing cationically polymerizable monomers from a polymerizable monomer stream, at least one catalyst, at least one co-catalyst, and optionally a solvent into a milli-channel reactor; and
(b) continuously polymerizing at least a portion of the polymerizable monomers to form polyisobutylene within a reaction mixture.

2. The process of claim 1, wherein the polymerizable monomer stream, at least one catalyst, optionally a solvent, and at least one co-catalyst, are mixed to produce polyisobutylene, wherein:
the polymerizable monomer stream is a hydrocarbon mixture having an isobutylene concentration in a range of 5-80% by weight;
the catalyst is selected from a group consisting of aluminum chloride (AlCl₃), titanium tetrachloride (TiCl₄), ethyl aluminum dichloride (EtAlCl₂), 1-ethyl-3-methylimidazolium tetra chloroaluminate (Emim [AlCl₄]) and 1-ethyl-3-methylimidazolium tetrachloroferrate (Emim [FeCl₄]);
the co-catalyst is selected from the group consisting of water, dibutyl ether (C₈H₁₈O), Di isopropyl ether (iPr₂O) and diethyl ether (Et₂O); and
the optional solvent stream is selected from a group consisting of toluene, hexane, isopentane, methylcyclohexane, alkanes, an unreacted fraction of the said polymerizable monomer stream, or mixtures thereof.

3. The process of claims 1, wherein the at least one catalyst is introduced into the reactor in the form of a solution or suspension in organic media, and wherein:
(a) the solution comprises a dilution of the catalyst in one or more organic solvents in a proportion of 5 to 20 wt. % catalyst, the organic solvents being selected from a group consisting of n-hexane, isopentane, n-heptane, iso-octane, n-octane, n-butane, isobutane a C4 cut, or mixtures thereof;
(b) the suspension comprises a mixture of the catalyst with polyisobutylene, mineral oil, grease, or mixture thereof, said mixtures containing 2 to 30 wt. % catalyst, and
(c) the catalyst solution or catalyst suspension is transferred to the reactor through pumping, or any other pressure differential means.

4. The process of claim 1, wherein a mass concentration of catalyst relative to the polymerizable monomer present in the polymerizable stream is in a range of 1,600 to 40,000 ppm.

5. The process of claim 1, wherein the continuous polymerizing comprises a cationic polymerization.

6. The process of claim 5, where the cationic polymerization comprises an initiation step wherein the catalyst and the co-catalyst react to form an acid complex that functions as a proton donor.

7. The process of claim 6, wherein the co-catalyst is added separately or is present in the polymerizable monomer stream.

8. The process of claim 6, wherein the catalyst to co-catalyst mass ratio is in a range of 300 to 2,800 wt./wt.

9. The process of claim 1, wherein the catalyst and the polymerizable monomer stream can be mixed immediately upstream of the milli-channel reactor, at an entrance of a first reactor zone, or at different points along a length of the milli-channel reactor.

10. The process of claim 1, wherein the polymerization occurs in one or more milli-channel reactors, wherein:
(a) the milli-channel reactor is a microreactor comprising a shell-and-tube configuration comprising tubes and a reactor shell, wherein the tubes are also referred to as channels;
(b) the milli-channel reactor has a surface-to-volume ratio of at least 500 m²/m³;
(c) each of the channels of the said milli-channel reactor is identical to the others;
(d) each of the channels can optionally be filled with micro structured static mixers, a block of micro structured static mixers, or baffles; and
(e) a reactor temperature is controlled using an external refrigeration fluid system, wherein the fluid system is pumped through the reactor shell.

11. The process of claim 1, wherein the polymerization occurs under predetermined process conditions, comprising:
(a) a temperature range of 20 to 100° C.;
(b) a residence time in a range of 1 minute to 7 minutes; and
(c) a pressure in a range of 5 to 100 kgf/cm²

12. The process of claim 1, further comprising at least the following steps:
(a) catalyst neutralization;
(b) treating the reaction mixture;
(c) recovering unreacted hydrocarbons, solvent, and oligomers and optionally recycling them to the reactor; and
(d) separating the polyisobutylene from the reaction mixture.

13. The process of claim 1, wherein the polyisobutylene is classified as light-polyisobutylene, low molecular weight polyisobutylene, or intermediate molecular weight polyisobutylene, and said polyisobutylene comprises:
(a) a number average molecular weight between 280 to 1500 g/mol;
(b) a viscosity of 5 to 120 cSt at 37.8° C., measured according to ASTM D-445 Standard; and
(c) a polydispersity index between 1 and 3.
